(19) United States
(12) Patent Application Publication
(10) Pub. No.: US 2003/0150240 A1
(43) Pub. Date: Aug. 14, 2003

(54) Automatic machine for working materials in sheet form, particularly glass sheets

(75) Inventor: Franco Bavelloni, San Fermo Della Battaglia (IT)

Correspondence Address: MODIANO & ASSOCIATI, Via Meravigli, 16, 20123 MILANO, IT

(73) Assignee: Z. BAVELLONI S.p.A.

(21) Appl. No.: 10/270,380

(22) Filed: Oct. 15, 2002

(30) Foreign Application Priority Data
Feb. 12, 2002 (IT) MI2002A000267

(51) Int. Cl. C03B 1/00

(52) U.S. Cl. 65/375

(57) ABSTRACT

An automatic machine for working materials in sheet form, particularly glass sheets, which comprises a supporting framework that has a worktable for supporting the sheet being worked with suction cup elements and a tool magazine. A frame for supporting a working head is associated with the framework, the head being able to move above the worktable. A pick-up tool that can be moved by the working head is provided, to pick up suction cup elements from a magazine and position them on the worktable and/or vice versa.

### BACKGROUND OF THE INVENTION

The present invention relates to an automatic machine for working materials in sheet form, particularly glass sheets.

It is known that in automatic machines for working materials in sheet form and particularly in machines that perform the perimetric edge and surface working of glass sheets, the sheets are held in position on the worktable of the machine by means of suction cups that are structured so as to connect to the worktable and define, in an upward region, a plurality of suction cups for supporting the sheet being worked.

If the suction cup elements must also position the sheet on the worktable, so that the machine can perform the intended work steps in automatic succession, the suction cup elements must be applied exactly in a preset position.

With currently known solutions, it is the operator who manually positions the suction cups, arranging them according to templates or optionally by utilizing the automatic systems of the machine, which indicate precisely where the suction cups are to be applied.

This solution is hardly practical, both because the operator must in practice climb onto the worktable, in the case of large dimensions with placement of the suction cup elements at a certain distance from the edge, and because positioning correctness is in practice eventually entrusted to the meticulousness of the operator.

Another problem consists in that the operator must in practice lean over a region where the working head is present, with consequent safety-related risks.

Other known solutions use the working head to position the suction cups, but the hoses that convey the air must be connected manually to the already-positioned suction cups, with the risk of moving said suction cups and with the previously noted safety problems for the operator.

Moreover, suction cups provided with centering or positioning elements must be positioned manually, and therefore automatic positioning of only some of the suction cups is certainly not very useful.

### SUMMARY OF THE INVENTION

The aim of the present invention is to eliminate the above mentioned drawbacks, by providing an automatic machine for working materials in sheet form, particularly glass sheets, that allows to automatically position the suction cup elements in several points of the worktable that can be preselected at will without requiring the manual intervention of the operator.

Within this aim, an object of the present invention is to provide an automatic machine in which it is possible to achieve absolute positioning precision while keeping the operator at all times outside the working area, thus achieving considerable safety in operation.

Another object of the invention is to provide an automatic machine in which it is possible to achieve highly repeatable positioning, with a consequent optimum quality of results.

Another object of the present invention is to provide an automatic machine that can be easily obtained starting from commonly commercially available elements and materials and is further competitive from a merely economical point of view.

This aim and these and other objects that will become better apparent hereinafter are achieved by an automatic machine for working materials in sheet form, particularly glass sheets, which comprises a supporting framework that has a worktable for supporting the sheets being worked by means of suction cup elements, and a tool magazine, a frame for supporting a working head being associated with said framework, said head being able to move above said worktable, characterized in that it comprises a pick-up tool that can be moved by said working head in order to pick up suction cup elements from a magazine of suction cup elements and position them on said worktable and/or vice versa.

### BRIEF DESCRIPTION OF THE DRAWINGS

Further characteristics and advantages will become better apparent from the following detailed description of a preferred but not exclusive embodiment of an automatic machine for working materials in sheet form, particularly glass sheets, illustrated only by way of non-limitative example in the accompanying drawings, wherein:

FIG. 1 is a schematic plan view of the automatic machine according to the present invention;

FIG. 2 is a partially cutout elevation view of the automatic machine;

FIG. 3 is a front elevation view of the positioning of the pick-up tool in the tool holder magazine;

FIG. 4 is a top plan view of the positioning of the pick-up tool in the tool magazine;

FIG. 5 is a schematic perspective view of a clamp-type pick-up tool during its approach to a suction cup element located in the suction cup element magazine;

FIG. 6 is a perspective view of a pneumatic pick-up tool during approach to a suction cup element in the tool holder magazine;

FIG. 7 is a perspective view of the coupling between the pneumatic pick-up tool and the suction cup element;

FIG. 8 is a view of the step for picking up the suction cup element with centering device;

FIG. 9 is a sectional view of the pneumatic pick-up tool;

FIG. 10 is a view of an automatic suction cup element rested on the magazine;

FIG. 11 is a view of an automatic suction cup element rested on the worktable;

FIG. 12 is a schematic view of a machine with a suction cup magazine;

FIG. 13 is an elevation view of the suction cup magazine, illustrating the hose connection sheath;

FIG. 14 is a view of a suction cup with centering element, provided with orientable connectors for the air hoses.

### DESCRIPTION OF THE PREFERRED EMBODIMENTS

With reference to the figures, the automatic machine for working materials in sheet form, particularly glass sheets, according to the invention, generally designated by the reference numeral 1, comprises a supporting framework 2 which, in a per se known manner, has a worktable 3 on which it is possible to position the sheets 4, particularly glass sheets, which must be subjected to perimetric edge and/or surface working, which can be constituted for example by working the edges or by working performed on the surface of the sheet.

The sheet 4 is kept in position by means of suction cup elements, designated by the reference numeral 5, and by means of suction cup elements with a centering device, which are designated by the reference numeral 6. The suction cup elements 5 and 6 are of a per se known kind and are respectively designed to retain the sheet, and, to retain it and also provide, by means of the centering device, locators for correctly positioning the sheet to be worked.

The suction cup elements 5 and 6 are connected, in a per se known manner, by way of lines 7, to a vacuum source VS in order to fix, in a known manner, the suction cup elements to the working table 3 and the sheet 4 to the suction cup elements.

The lines 7 are preferably of the spiral type, differently from what occurs in the prior art, in which the straight hoses must be cut to size in each instance according to the distance between the suction cup element and the manifold for connection to the vacuum source, thus increasing machine preparation times.

Laterally adjacent to the worktable 3 there is a tool magazine, generally designated by the reference numeral 8, on which the tools picked in succession by the working head 9 to perform the various working steps are arranged.

The working head 9 is connected to a frame 10 that lies above the worktable 3, so as to allow the working head 9 to perform movements above the worktable in both directions.

Furthermore, the working head 9, in a per se known manner, has movements about its vertical axis, which is commonly known as C axis.

In these kinds of machine it is necessary to position the suction cup elements, and especially for suction cup elements provided with a centering device 6 it is necessary to perform precise positioning, because such elements are those that allow to provide the corresponding positioning of the sheet to be subsequently worked.

The particularity of the invention consists in that there is a pick-up tool, generally designated by the reference numeral 20, which can be arranged in the tool magazine 8 and can be picked up by the working head 9 to perform, in automatic succession, the transfer of the suction cup elements 5 and 6 onto the worktable, said elements being taken from a suction cup element magazine 15, on which the suction cup elements are arranged; said suction cup elements are picked up by the working head and placed precisely in the intended point of the worktable 3; the number of suction cup elements provided on the magazine can vary according to the productivity requirements of the machine.

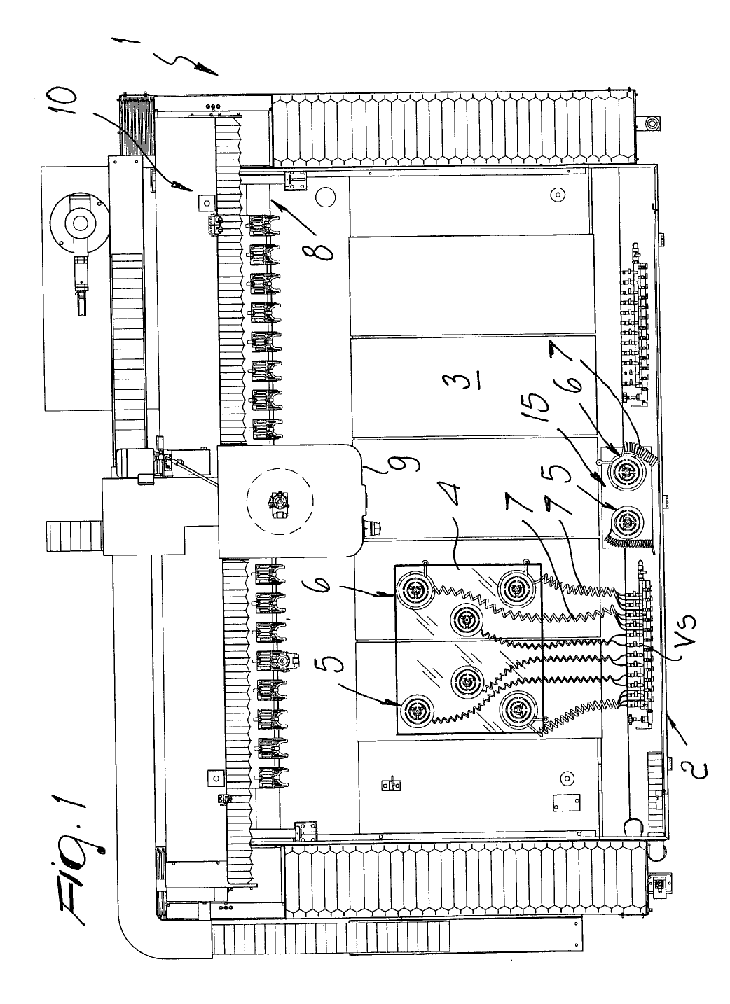

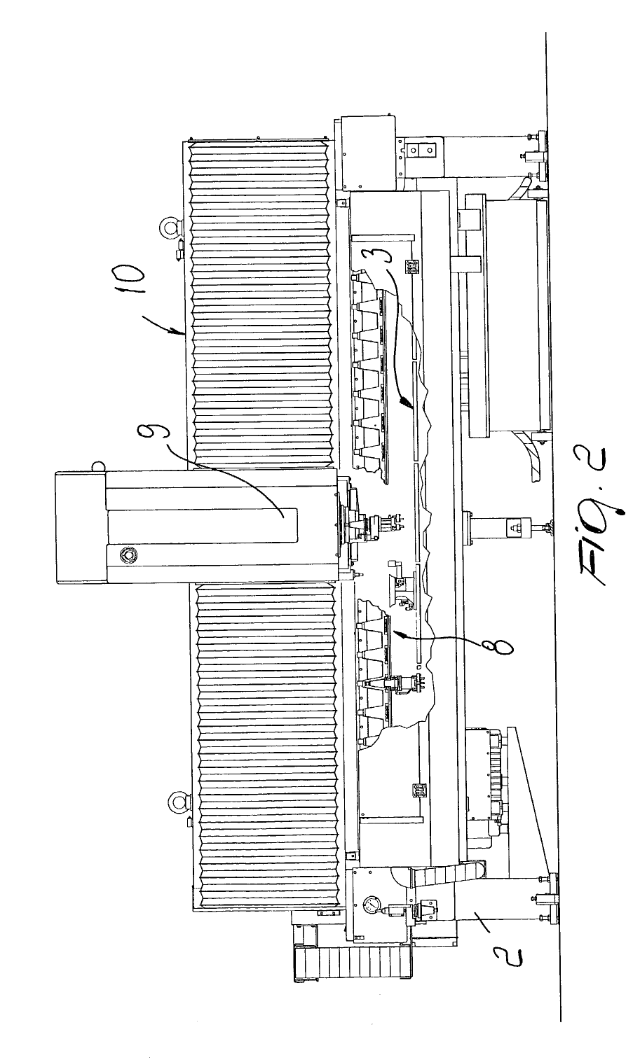

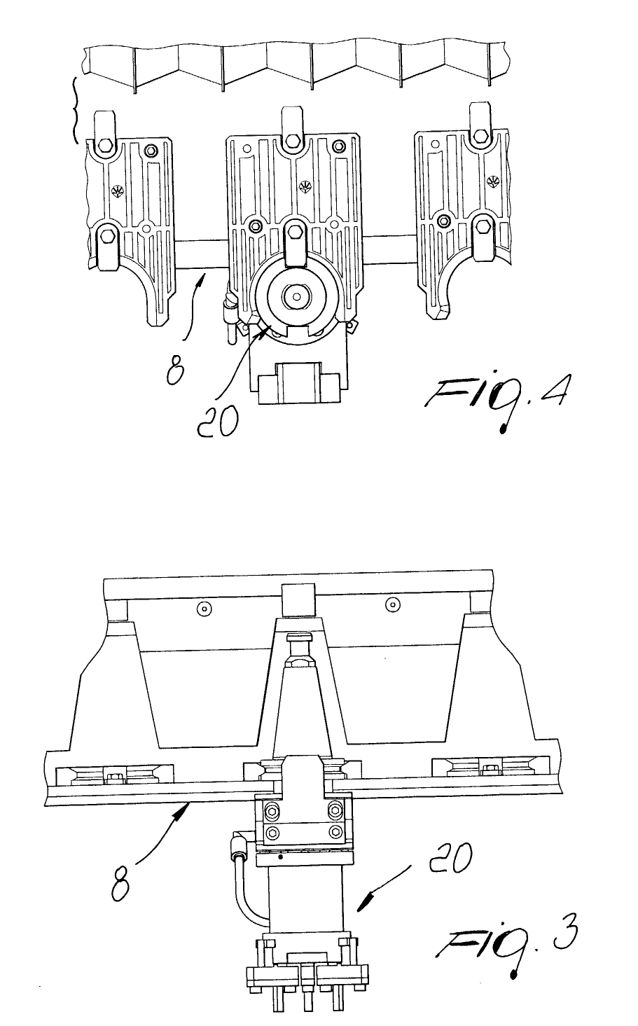

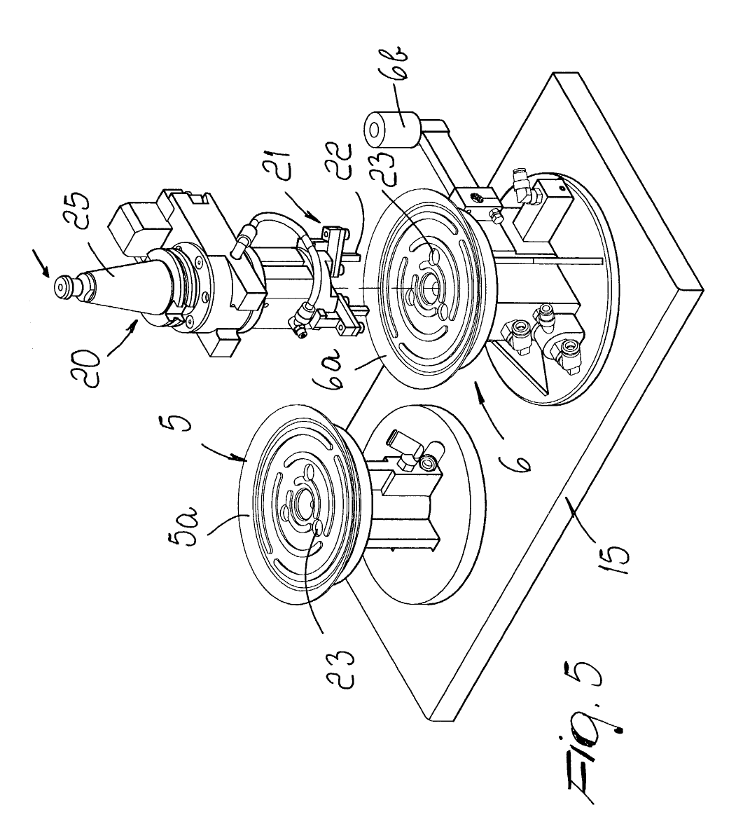

As shown in FIGS. 1 to 5, there is a pick-up tool 20 that is provided with grip clamps, generally designated by the reference numeral 21, which are constituted in practice by pins 22 that can move radially and can be inserted in centering holes 23 formed in the suction cup elements 5 and in the suction cup elements 6.

The pick-up action performed in a central position, with respect to the upper part of the suction cup element, allows to have a single pick-up tool regardless of the dimensions of the suction cup element.

The pick-up element or tool 20 is provided with the typical cone 25 for its connection to the working head.

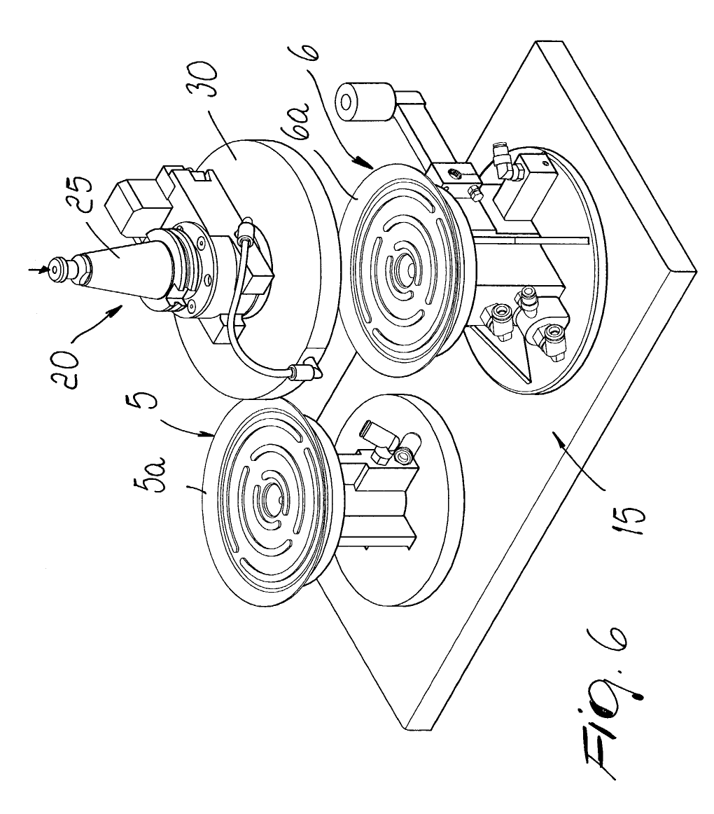

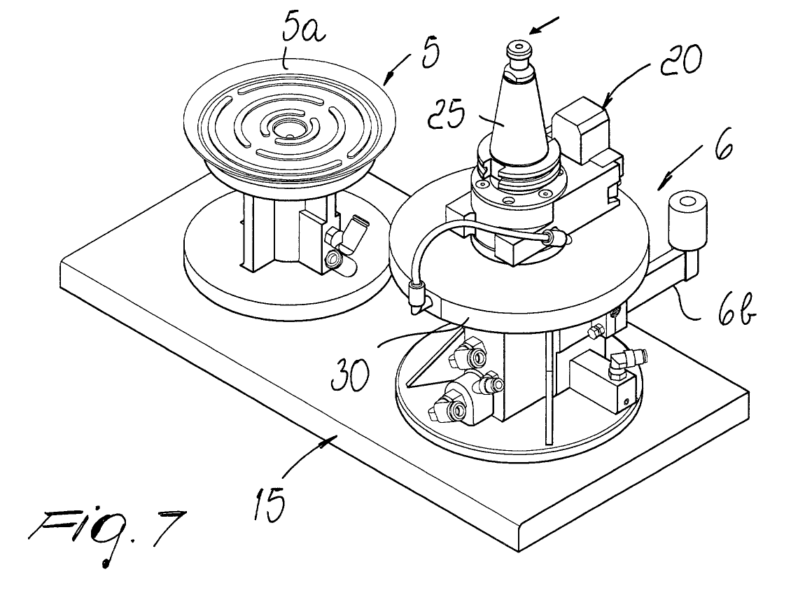

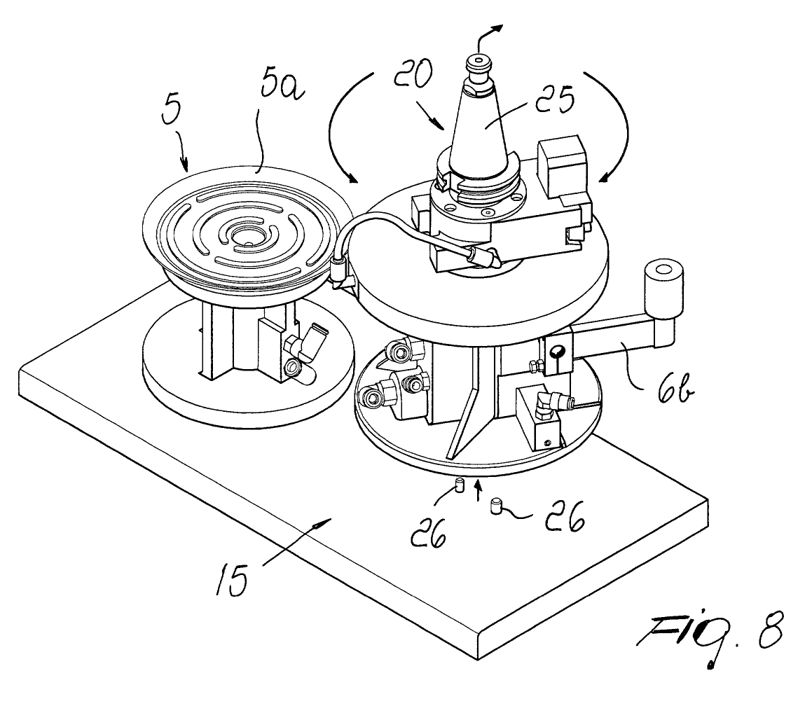

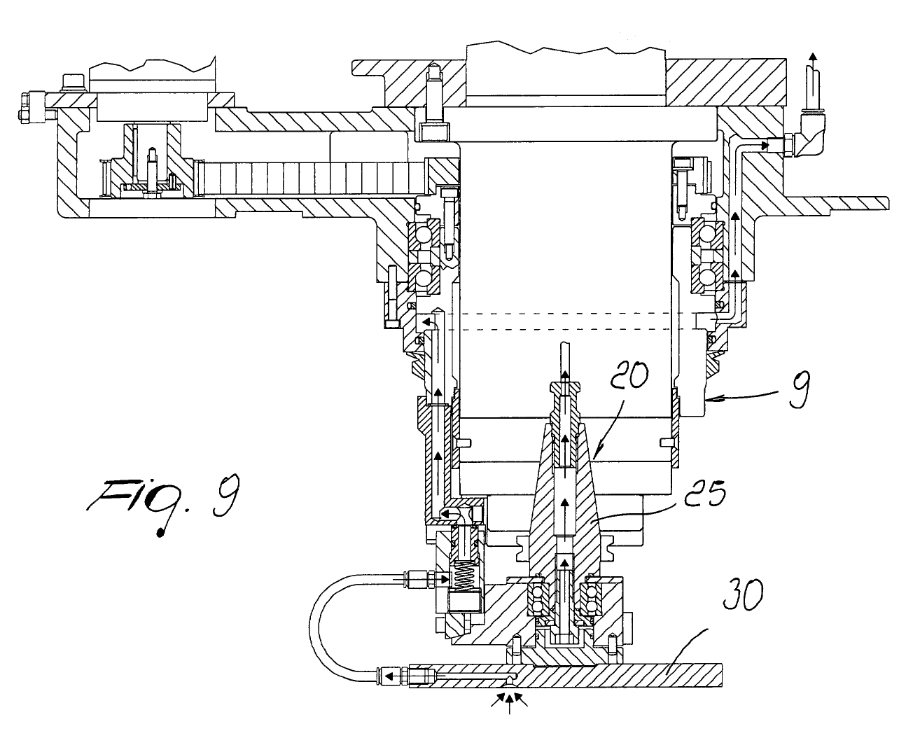

According to a different structural embodiment of the pick-up element 20, and according to what is shown in FIGS. 6 to 9, the pick-up element 20 can have a pneumatic plate 30, which can be connected to the vacuum source VS provided in the machine by means of a connection that can be provided directly on the working axis or optionally by means of the lateral outlet of the pick-up element body, which is otherwise closed.

The vacuum plate, by engaging the suction cups 5a and 6a provided in an upward region with respect to the suction cup elements 5 and 6, can perform engagement in a very practical and rapid manner, thus allowing to pick up the suction cup elements and convey them until they are positioned.

It should be added to the above that in the suction cup element magazine 15 there are positioning means 26 for the orientated positioning of the suction cup elements, which are constituted by two pin elements of mutually different sizes that force a single positioning, so that the suction cup elements with centering device are positioned so that the centering device, designated by the reference numeral 6b, is always in the same angular position.

In this manner, the working head, by means of the pick-up tool, picks up the suction cup element and can perform the preset angular rotation, thus achieving a precise angular positioning of the centering device.

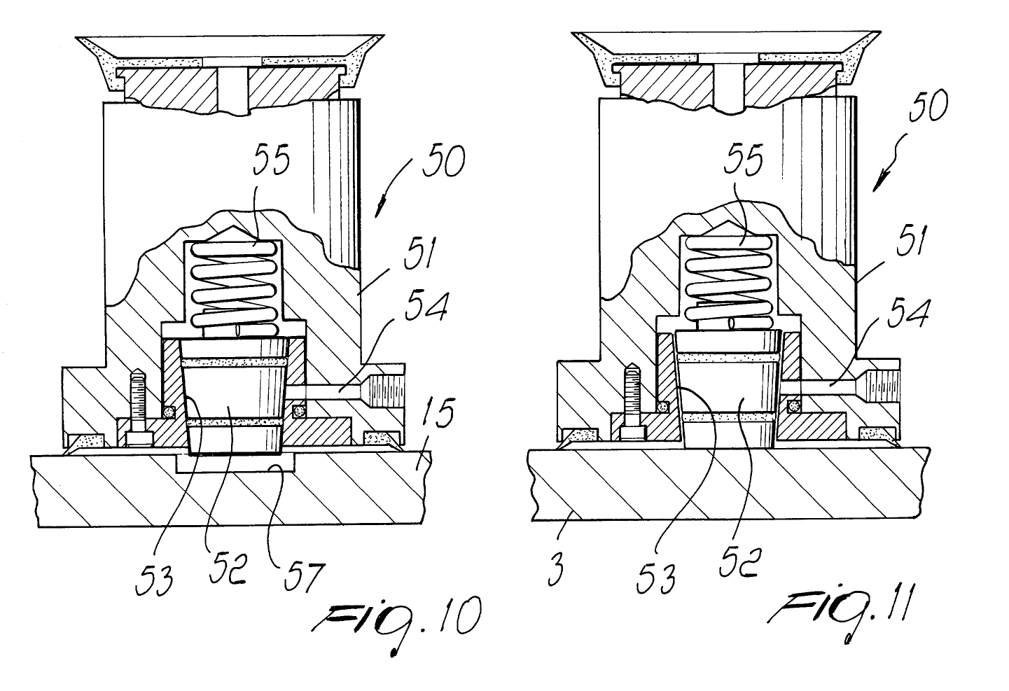

As shown in FIGS. 10 and 11, it is possible to use automatic suction cup elements 50, by means of which the connection to the vacuum source VS is provided automatically as soon as the suction cup elements are positioned on the worktable.

For this purpose, on the body 51 of the automatic suction cup element 50 there are control means, constituted by a flow control element 52 contained in a seat 53 into which the lower intake duct 54 leads; the flow control element is pushed by elastic means, such as a spring 55 and its lower end protrudes from the lower face of the body 51.

By resting the suction cup element 50 on the worktable 3, the actuator 52 is moved upward and, by being frustum-shaped, frees the connection to the duct 54; the vacuum that locks in position the suction cup element is thus generated automatically.

A recess 57 is provided on the magazine 15, at the region affected by the suction cup element, in order to avoid disengaging of the flow control element and allow the suction cup element to be picked up.

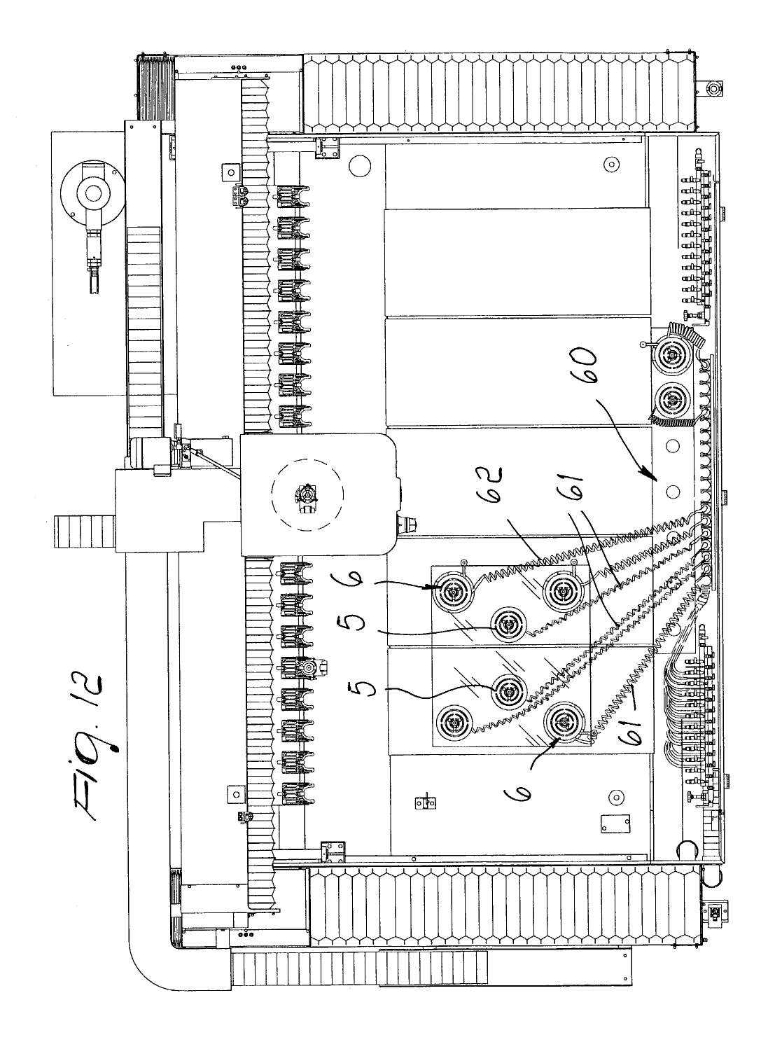

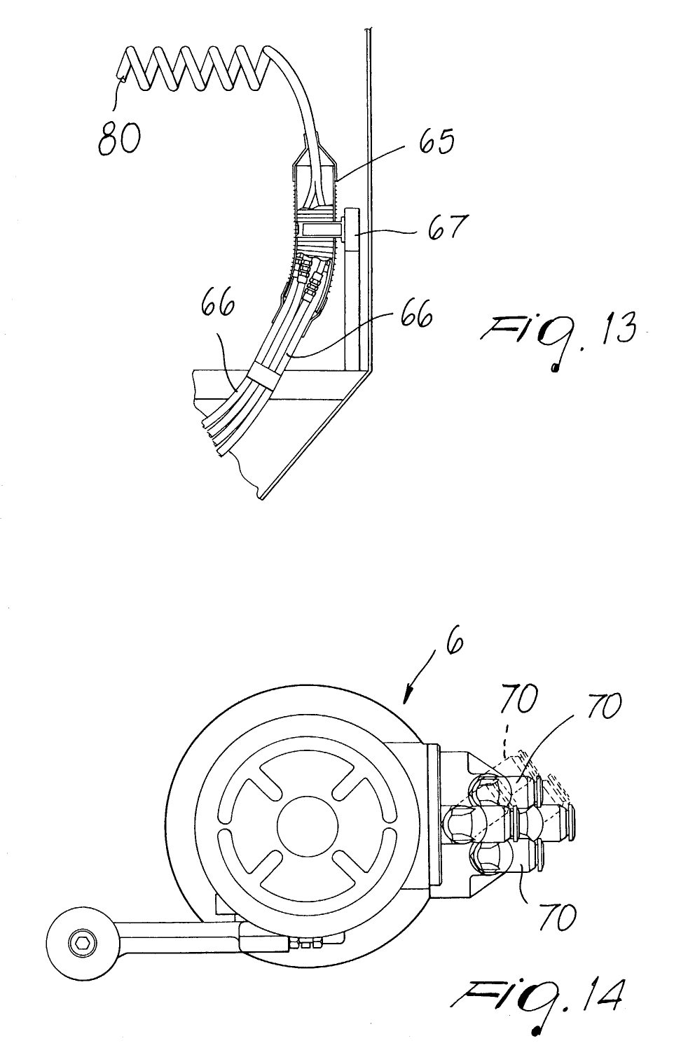

Specifically with reference to FIGS. 12 and 13, the machine can be provided with a suction cup magazine, designated by the reference numeral 60, which is preset to allow the simultaneous positioning of a number of suction cup elements, again designated by the reference numerals 5 and 6, sufficient for at least one working station.

In the specific example shown, the suction cup magazine is preset to accommodate the suction cups in two separate working stations that are formed on the same working surface.

The particularity of the present invention consists in that the suction cup elements are already connected to the corresponding duct and in particular flexible spiral hoses, designated by the reference numeral 61, which are provided for two ducts and are used for the suction cups 5, and flexible spiral hoses 62 which are provided having four ducts and are used for the suction cups having a positioning element.

To perform the connection, there is a connection sheath 65 for the semirigid hoses 66 that connect to the air and vacuum manifolds 80.

The sheaths 65 can be coupled in sheath retainers or rack 67 provided on the suction cup magazine 60.

In this manner it is possible to perform automatic positioning of the suction cups, which is performed by the machine by virtue of an appropriate program that reduces drastically the machine setup times, and the operator works in full safety without climbing on and off the machine.

Moreover, the fact that the magazine contains a sufficient number of suction cups to prepare at least one working station allows the pick-up tool to position the suction cups automatically in succession without having to remove the connection hoses that are fixed in the clips of the sheath retainers 67.

By way of the management program, the machine can perform the sequential positioning of the suction cups without overlapping the spiral hoses and without hindrances caused by already-positioned suction cups.

To facilitate the connection of the suction cups 6 provided with a centering element, for which the orientation around the so-called C axis or vertical axis cannot be changed, advantageously there are, as shown in FIG. 14, rotary connectors with orientation means 70 for inlets of the four hoses, thus allowing to facilitate the orientation of the hoses and to reduce overlaps or the possibility of bends.

In practical operation, therefore, the machine can be programmed to use the pick-up tool like any other tool, taking it automatically from the tool magazine and with the possibility to pick up the various suction cup elements, positioning them on the worktable very rapidly and safely by achieving their automatic locking when release occurs.

It should also be noted that the pick-up tool is structured so that it can engage the suction cup elements regardless of the dimensions of the upper suction cup and always so as to allow precise angular positioning.

The invention thus conceived is susceptible of numerous modifications and variations, all of which are within the scope of the appended claims.

All the details may further be replaced with other technically equivalent elements.

In practice, the materials used, as well as the contingent shapes and dimensions, may be any according to requirements.

The disclosures in Italian Patent Application No. MI2002A000267 from which this application claims priority are incorporated herein by reference.

What is claimed is:

1. An automatic machine for working materials in sheet form, comprising: a supporting framework; a worktable supported at said framework for supporting a sheet to be worked; suction cup elements, for keeping in position the sheet to be worked; a tool magazine; a suction cup elements magazine; a frame associated with said framework; a working head supported at said frame for moving above said worktable; and a pick-up tool that is actuatable in motion by said working head in order to pick up the suction cup elements from said suction cup elements magazine and position said suction cup elements on said worktable and to move back the suction cup elements to said suction cup elements magazine.

2. An automatic machine for working materials in sheet form, comprising: a supporting framework; a worktable supported at said framework for supporting a sheet to be worked; suction cup elements for keeping in position the sheet to be worked; a suction cup magazine for positioning a number of said suction cup elements sufficient at least for constituting one working station; and air and vacuum hoses connected to said suction cup elements, arranged in said suction cup magazine.

3. The automatic machine of claim 1, wherein said tool magazine is adapted to receive said pick-up tool positioned so as to be removable therefrom by way of said working head.

4. The automatic machine of claim 1, wherein said suction cup elements comprise centering holes formed in the upper part thereof, and said pick-up tool has a grip clamp constituted by radially movable pins that are inserted in said centering holes of said suction cup elements.

5. The automatic machine of claim 1, further comprising a vacuum source and suction cups formed at the upper ends of said suction cup elements, said pick-up tool comprising a pneumatic plate that can be connected to said vacuum source and is operatable to engage said suction cups.

6. The automatic machine of claim 1, further comprising positioning means for positioning said suction cup elements arranged on said suction cup element magazine.

7. The automatic machine of claim 6, wherein said positioning means for said suction cup elements are constituted by two mutually different pin elements.

8. The automatic machine of claim 7, wherein said pin elements have mutually different dimensions.

9. The automatic machine of claim 5, wherein said pick-up tool has a cone for connection to said working head.

10. The automatic machine of claim 2, further comprising a sheath locking rack arranged in said suction cup magazine, and sheaths, said hoses including spiral hoses of said suction cup elements and the semirigid hoses for connection to air and vacuum manifolds, and said sheaths being retained on said racks for connecting said spiral hoses to said semirigid hoses.

11. The automatic machine of claim 10, further comprising connectors for connection to said hoses which are provided with orientation means, said connectors being provided at least on said suction cup elements with centering element.

12. The automatic machine of claim 1, comprising: a vacuum source; a lower intake duct connected to said vacuum source; at least one automatic suction cup element having a suction cup body and a lower suction cup; said suction cup element including a region thereof that is connected to said lower intake duct; flow control means for controlling fluid flow through said lower intake duct so as to free connection to said region connected to said lower intake duct when the suction cup element is rested automatically on said worktable.

13. The automatic machine of claim 12, wherein said flow control means comprises a flow control element that is contained in a seat of said suction cup body, and into which said lower intake duct leads, and a lower end of said flow control element protruding from the lower face of said suction cup body.

14. The machine of claim 13, further comprising elastic means provided so as to bias said flow control element.

15. The machine of claim 14, wherein said flow control element is frustum-shaped.
